(19) United States
(12) Patent Application Publication
(10) Pub. No.: US 2004/0111537 A1
(43) Pub. Date: Jun. 10, 2004

(54) Method, system, and program for processing operations

(75) Inventors: Patrick L. Connor, Portland, OR (US); Patrick J. Luhmann, Hillsboro, OR (US); Gregory D. Cummings, Portland, OR (US)

Correspondence Address: KONRAD RAYNES VICTOR & MANN LLP, Suite 210, 315 S. Beverly Drive, Beverly Hills, CA, 90212, US

(73) Assignee: Intel Corporation

(21) Appl. No.: 10/313,781

(22) Filed: Dec. 5, 2002

(51) Int. Cl. G06F 3/00

(52) U.S. Cl. 710/6

(57) ABSTRACT

Disclosed is a method, system, and program for processing an operation. If previously issued operations are being processed, deferring operation processing. If previously issued operations are not being processed, the operation and any operations for which operation processing was previously deferred and that require operation processing are issued.

### BACKGROUND OF THE INVENTION

1. Field of the Invention

The present invention relates to a method, system, and program for processing operations.

2. Description of the Related Art

In computer systems, components are coupled to each other via one or more buses. A variety of components can be coupled to a bus, thereby providing intercommunication between all of the various components. An example of a bus that is used for data transfer between a memory and another device is the peripheral component interconnect (PCI) bus.

In order to relieve a processor of the burden of controlling the movement of blocks of data inside of a computer, direct memory access (DMA) transfers are commonly used. With DMA transfers, data can be transferred from one memory location to another memory location, or from a memory location to an input/output (I/O) device (and vice versa), without having to go through the processor. Additional bus efficiently is achieved by allowing some of the devices connected to the PCI bus to be DMA masters.

When transferring data using DMA techniques, high performance I/O controllers, such as gigabit Ethernet media access control (MAC) network controllers may be used. In particular, a host computer includes an Input/Output (I/O) controller for controlling the transfer of data packets to and from, for example, other computers or peripheral devices across a network, such as an Ethernet local area network (LAN). The term “Ethernet” is a reference to a standard for transmission of data packets maintained by the Institute of Electrical and Electronics Engineers (IEEE) and one version of the Ethernet standard is IEEE std. 802.3, published Mar. 8, 2002.

To read a data buffer of a memory using DMA transfers, such as when the data has to be retrieved from memory in response to a transmit command from an operating system so that the data can be transmitted by the I/O controller, a device driver for the I/O controller prepares the data buffer. A transmit command may be any indication that notifies the device driver of a data packet to be transferred, for example, over a network. The device driver prepares and writes one or more descriptors (i.e., that include the data buffer's physical memory address and length, etc.) to a command register of the I/O controller to inform the I/O controller that one or more descriptors are ready to be processed by the I/O controller. The I/O controller then DMA transfers the one or more descriptors from memory to another buffer and obtains the data buffer's physical memory address, length, etc. After the I/O controller has processed the one or more descriptors, the I/O controller can DMA transfer the contents/data in the data buffer.

A device driver writes descriptors to the I/O controller as the device driver receives transmit commands from an operating system. There are three bus accesses for processing each transmit command. The first access is a write by the device driver to a command register of the I/O controller to inform the I/O controller that a new descriptor is ready to be processed. The second access is a read of the descriptor by the I/O controller. The third access is the I/O controller reading a data packet in a data buffer identified in the descriptor. The first access has the opportunity to interfere with the bus operations of previously written descriptors. That is, while the I/O controller is reading a data packet for a first descriptor, if the device driver submits a second descriptor, the I/O controller's reading of the data packet for the first descriptor is interrupted. Additionally, the second access by the I/O controller has latencies caused by reading one descriptor at a time.

Thus, one of the bottlenecks in transmit command processing has been identified as the peripheral bus. Even if a high-speed I/O controller is the only active device on the bus, the overhead accesses relating to writing descriptors from the device driver to the I/O controller can hinder bus activity needed to process the transfer of data identified by the descriptors, and this reduces the performance of the I/O controller.

Therefore, there is a need for an improved technique for issuing operations, such as descriptors.

### BRIEF DESCRIPTION OF THE DRAWINGS

Referring now to the drawings in which like reference numbers represent corresponding parts throughout:

FIG. 1 illustrates a computing environment in which aspects of the invention may be implemented.

FIG. 2 illustrates a format of a data packet in accordance with certain embodiments of the invention.

FIG. 3 illustrates logic implemented in a device driver for handling receipt of a new transfer operation in accordance with certain embodiments of the invention.

FIG. 4 illustrates logic implemented in a device driver when a transfer operation has been processed by an I/O controller in accordance with certain embodiments of the invention.

FIG. 5 illustrates logic implemented in a device driver when a transfer operation has been processed by an I/O controller in accordance with certain alternative embodiments of the invention.

FIG. 6 illustrates logic implemented in a device driver when a transfer operation has been processed by an I/O controller in accordance with certain alternative embodiments of the invention.

FIGS. 7A and 7B illustrate logic implemented in a device driver for processing transfer operations in accordance with certain alternative embodiments of the invention.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

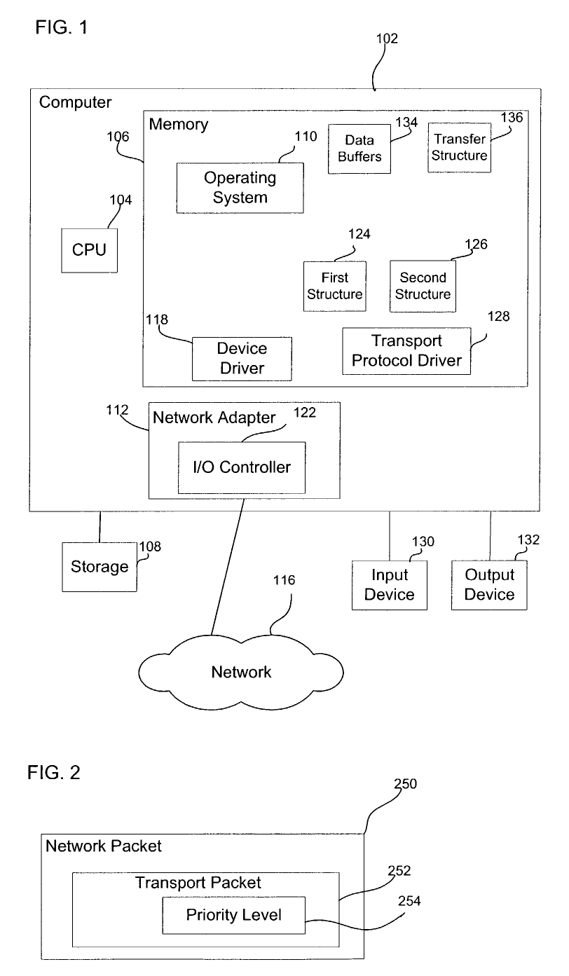

FIG. 1 illustrates a computing environment in which aspects of the invention may be implemented. A computer 102 includes a central processing unit (CPU) 104, a volatile memory 106, non-volatile storage 108 (e.g., magnetic disk drives, optical disk drives, a tape drive, etc.), an operating system 110, and a network adapter 112. The computer 102 may comprise any computing device known in the art, such as a mainframe, server, personal computer, workstation, laptop, handheld computer, telephony device, network appliance, vitalization device, storage controller, etc.

Any CPU 104 and operating system 110 known in the art may be used. The network adapter 112 includes a network protocol for implementing the physical communication layer to send and receive network packets to and from remote devices over a network 116. The network adapter 112 includes an I/O controller 122. In certain embodiments, the I/O controller 122 may comprise an Ethernet Media Access Controller (MAC) or network interface card (NIC), and it is understood that other types of network controllers, I/O controllers such as small computer system interface (SCSI controllers), or cards may be used.

The network 116 may comprise a Local Area Network (LAN), the Internet, a Wide Area Network (WAN), Storage Area Network (SAN), etc. In certain embodiments, the network adapter 112 may implement the Ethernet protocol, token ring protocol, Fibre Channel protocol, Infimiband, Serial Advanced Technology Attachment (SATA), parallel SCSI, serial attached SCSI cable, etc., or any other network communication protocol known in the art.

The storage 108 may comprise an internal storage device or an attached or network accessible storage. Programs in the storage 108 are loaded into the memory 106 and executed by the CPU 104. An input device 130 is used to provide user input to the CPU 104, and may include a keyboard, mouse, pen-stylus, microphone, touch sensitive display screen, or any other activation or input mechanism known in the art. An output device 132 is capable of rendering information transferred from the CPU 104, or other component, such as a display monitor, printer, storage, etc.

A device driver 118 includes network adapter 112 specific operations to communicate with the network adapter 112 and interface between the operating system 110 and the network adapter 112. In particular, the device driver 118 controls operation of the I/O controller 122 and performs other operations related to the reading of data packets from memory 106. The device driver 118 may be software that is executed by CPU 104 in memory 106.

In addition to the device driver 118, the computer 102 may include other drivers, such as a transport protocol driver 128. The transport protocol driver 128 executes in memory 106 and processes the content of messages included in the packets received at the network adapter 112 that are wrapped in a transport layer, such as TCP and/or IP, Internet Small Computer System Interface (iSCSI), Fibre Channel SCSI, parallel SCSI transport, or any other transport layer protocol known in the art.

In certain embodiments, the device driver 118 issues operations (e.g., writes descriptors) to the I/O controller 122. Although an operation may be any type of information, command, etc., for examples described herein, the term “transfer operation” will be used to refer to an operation that provides information about data for transfer (e.g., across an Ethernet LAN). Other operations (e.g., a storage operation that is used to store data into a structure) fall within the scope of the invention. An I/O controller 122 maintains one or more structures (e.g., a first structure 124 (e.g., a queue) and a second structure 126 (e.g., a queue)) for storing the transfer operations. In certain embodiments, the device driver 118 issues transfer operations to the I/O controller 122 and places the transfer operations in one or more of the structures 124, 126. The transfer operations identify data packets stored in one or more data buffers 134. The I/O controller 122 processes the transfer operations in structures 124, 126 to transfer data packets from data buffers 134 to a transfer structure 136 (e.g., a First In First Out (FIFO) queue) for transfer over, for example, network 116.

Several of the devices of FIG. 1 maybe directly or indirectly coupled to a bus (not shown). For instance, the device driver 118 and the I/O controller 122 may be coupled to the bus.

Although structures/buffers 124, 126, 132, and 134 are illustrated as residing in memory 106, it is to be understood that some or all of these structures/buffers may be located in a storage unit separate from the memory 106 in certain embodiments.

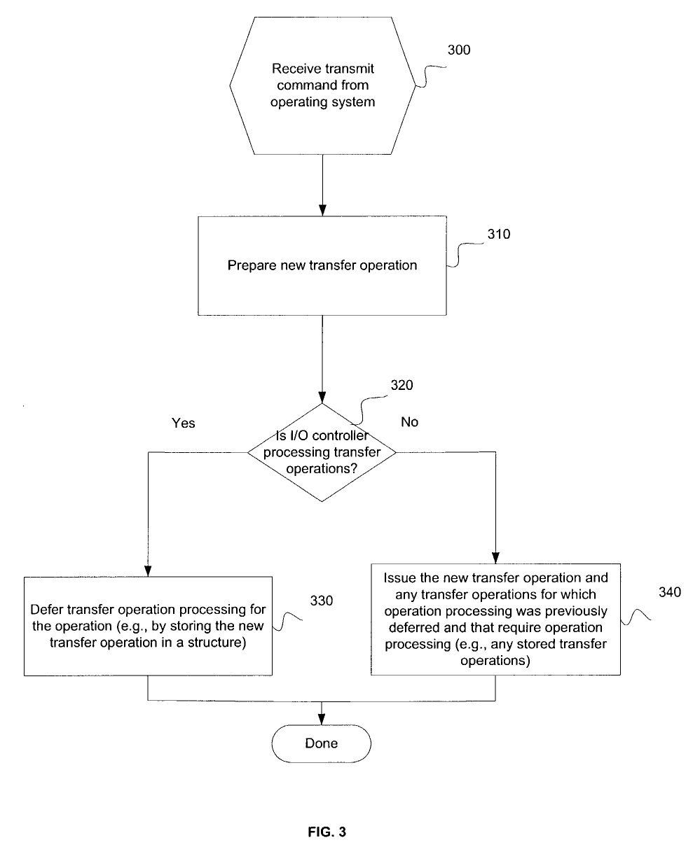

FIG. 2 illustrates a format of a data packet 250 in accordance with certain embodiments of the invention. The network packet 250 is implemented in a format understood by the network protocol 14, such as an Ethernet packet that would include additional Ethernet components, such as a header and error checking code (not shown). A transport packet 252 is included in the network packet 250. The transport packet may 252 comprise a transport layer capable of being processed by the I/O controller 22, such as the TCP and/or IP protocol, Internet Small Computer System Interface (iSCSI) protocol, Fibre Channel SCSI, parallel SCSI transport, etc. The transport packet 252 includes a priority level 254 as well as other transport layer fields, such as payload data, a header, and an error checking code. The payload data 252 includes the underlying content being transferred, e.g., operations, status and/or data. The operating system may include a device layer, such as a SCSI driver (not shown), to process the content of the payload data and access any status, operations and/or data therein.

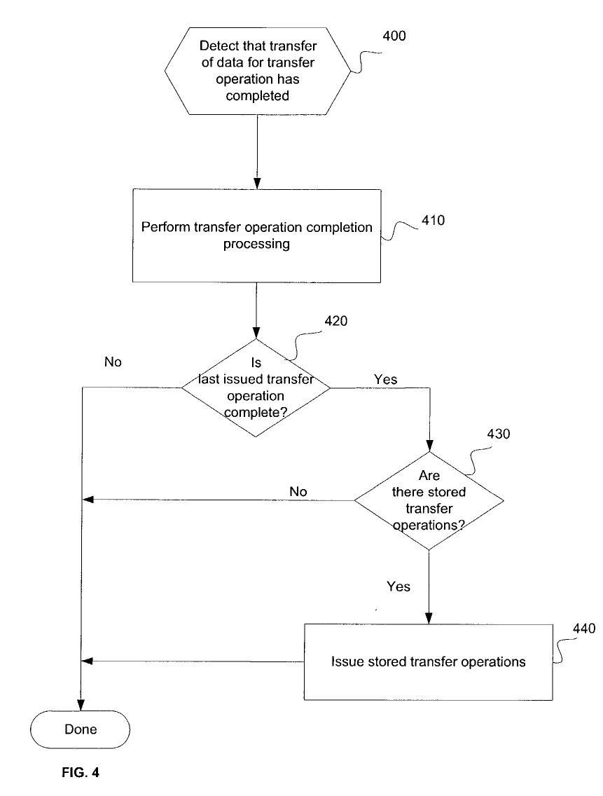

FIG. 3 illustrates logic implemented in a device driver 118 for handling receipt of a new transfer operation in accordance with certain embodiments of the invention. Control begins at block 300 with the device driver 118 receiving a transmit command issued by the operating system 110. In block 310, the device driver prepares a new transfer operation (e.g., creates a descriptor with the physical memory address and length of the data buffer in which a data packet for transfer resides). Instead of issuing the new transfer operation to the I/O controller 122 immediately upon receipt of the transmit command from the operating system 110, the device driver 118 first checks whether the I/O controller 122 is currently processing previously issued transfer operations (block 320). There are various techniques for checking whether the I/O controller is currently processing previously issued transfer operations. In certain embodiments, the device driver 118 may check the transfer operations, each of which has a bit that is set to indicate whether the descriptor has been processed. In certain embodiments, the device driver 118 receive an interrupt that is generated to indicate that a transfer operation has been processed, and the device driver 118 maintains a record of how many transfer operations have been issued and how many have been processed. In certain embodiments, the device driver 118 may read control registers of the I/O controller 122 to determine the status of the I/O controller 122.

In block 320, if the I/O controller 122 is processing other transfer operations, processing continues to block 330, otherwise, processing continues to block 340. In block 330, the device driver 118 defers processing of the transfer operation (e.g., by storing the new transfer operation in a structure, such as one of the structures 124, 126). If multiple structures are available, selection of one of the structures may be based on one or more factors, such as a priority level associated with the data packet identified by the transfer operation or the number of slots available in the structure (e.g., the transfer operation maybe stored in the structure 124, 126 which is storing fewer transfer operations). In block 340, the device driver 118 issues the new transfer operation along with any transfer operations for which operation processing was previously deferred and that require operation processing (e.g., along with any stored transfer operations). That is, when the I/O controller 122 completes processing previously issued transfer operations, the device driver 118 issues the new transfer operation and all transfer operations for which operation processing was previously deferred and that require operation processing (e.g., stored transfer operations) to the I/O controller 122 with a single bus access. This also allows the I/O controller 122 to read the new transfer operation and each of the other transfer operations with a single bus access. Thus, bus contention is avoided and latencies are amortized over multiple transfer operations.

By reducing the number of times the device driver 118 issues transfer operations to the I/O controller 122, bus utilization improves, which results in performance improvement for the entire system of components connected to a bus.

In certain embodiments of the invention, a Send Initiation function in the device driver 118 prepares all transfer operations, but does not necessarily issue them immediately to the I/O controller 122. Normal traffic flow generates subsequent transfer operations that clear any stored transfer operations. However, there may be gaps between flows that strand stored transfer operations. In certain embodiments of the invention, the process of issuing these stranded stored transfer operations is handled by a Send Completion function in the device driver 118. The Send Completion function runs after the I/O controller 122 processes a transfer operation in structures 124, 126 to transfer a data packet from data buffers 134 to a transfer structure 136 (e.g., a first in first out (FIFO) queue). The Send Completion function informs the operating system 110 that the data packet identified by the transfer operation has been transferred from data buffers 134 to transfer structure 136 and returns resources (e.g., memory used for the transfer) that may be used by subsequent transfer operations. The Send Completion function also issues the stored transfer operations to the I/O controller 122 when the last issued transfer operation has been completed.

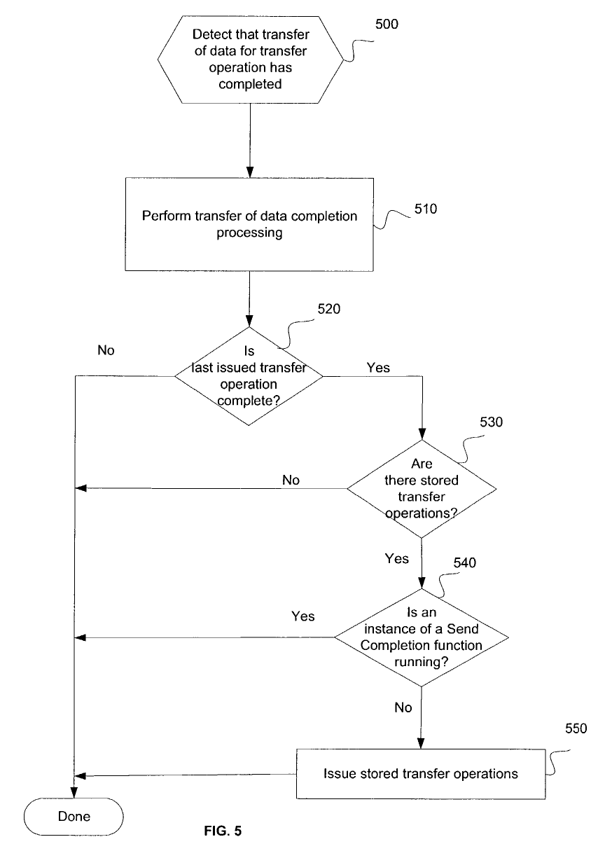

FIG. 4 illustrates logic implemented in a device driver 18 when a transfer operation has been processed by an I/O controller 122 in accordance with certain embodiments of the invention. Control begins at block 400 with the device driver 118 detecting that a transfer operation has completed (i.e., a data packet identified by a transfer operation has been transferred from data buffers 134 to a transfer structure 136). In block 410, the device driver 118 performs transfer operation completion processing.

In block 420, the device driver 118 determines whether the last issued transfer operation has completed. There are various techniques for determining whether the last issued transfer operation has completed. In certain embodiments, the device driver 118 may check the last issued transfer operations, which has a bit that is set to indicate whether the transfer operation has been processed. In certain embodiments, the device driver 118 receives an interrupt that is generated to indicate that a transfer operation has been processed, and the device driver 118 maintains a record of how many transfer operations have been issued and how many have been processed.

If the last issued transfer operation has completed, processing continues to block 430, otherwise, processing is done. In block 430, the device driver 118 determines whether there are any transfer operations stored in one or more structures (e.g., structures 124, 126). If so, processing continues to block 440, otherwise, processing is done. In block 440, the device driver 118 issues the stored transfer operations to the I/O controller 122. Thus, the I/O controller 122 does not go idle when the device driver 118 has transmit operations stored in structures 124, 126, which results in higher throughput and lower per-packet latency.

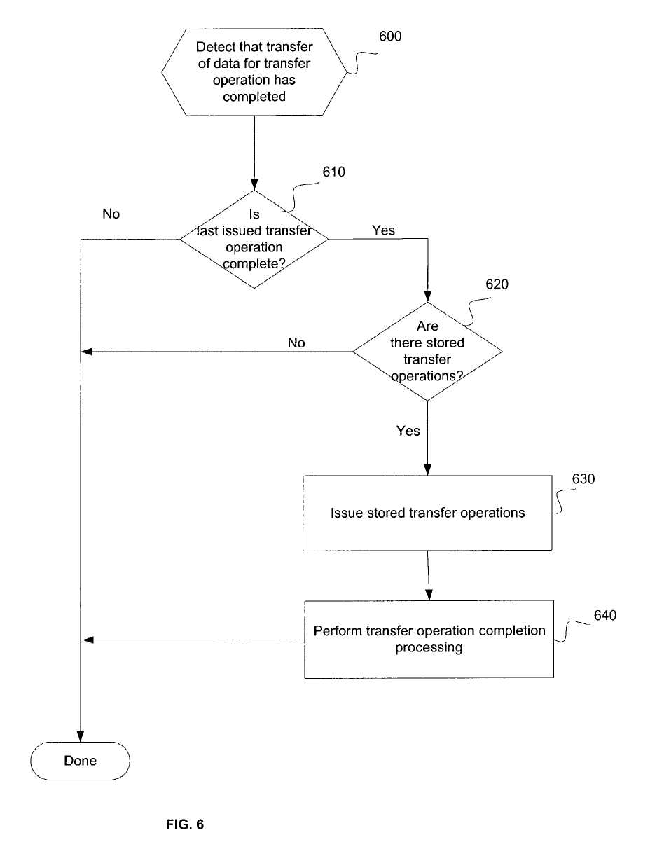

FIG. 5 illustrates logic implemented in a device driver 118 when a transfer operation has been processed by an I/O controller 122 in accordance with certain alternative embodiments of the invention. Control begins at block 500 with the device driver 118 detecting that a transfer operation has completed. In block 510, the device driver 118 performs transfer operation completion processing. In block 520, the device driver 118 determines whether the last issued transfer operation has completed. If so, processing continues to block 530, otherwise, processing is done. In block 530, the device driver 118 determines whether there are any transfer operations stored in one or more structures (e.g., structures 124, 126). If so, processing continues to block 540, otherwise, processing is done. In block 540, the device driver 118 determines whether an instance of a Send Completion function is running. If so, processing is done, otherwise, processing continues to block 550. In block 550, the device driver 118 issues the stored transfer operations to the I/O controller 122. That is, if an instance of the Send Completion function is running, then the device driver 118 does not issued the stored transfer operations. Then, the next time a new transfer operation is received, that new transfer operation, as well as, the stored transfer operations may be issued. This also avoids a race condition between two instances of the Send Completion function running simultaneously.

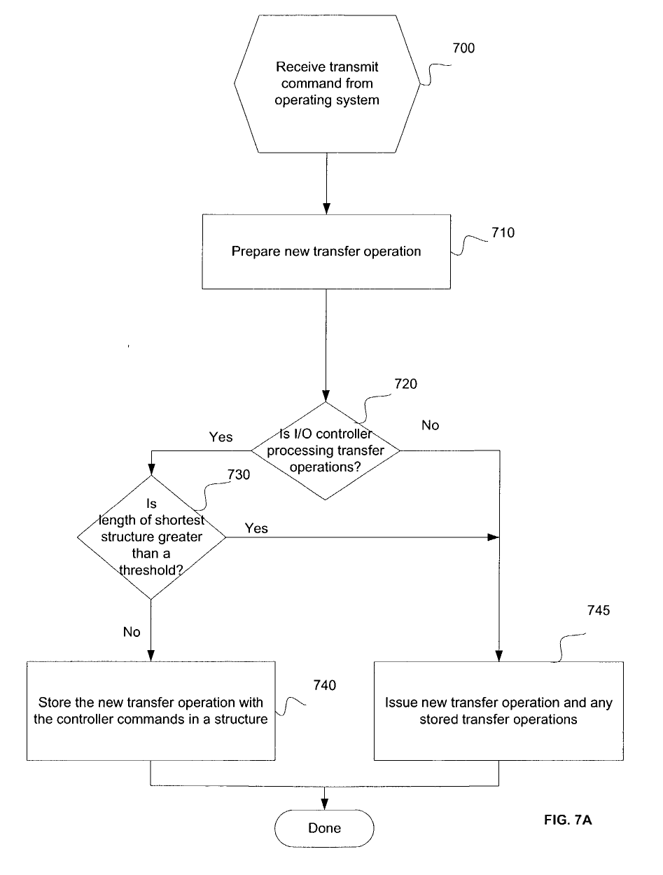

FIG. 6 illustrates logic implemented in a device driver 118 when a transfer operation has been processed by an I/O controller 122 in accordance with certain alternative embodiments of the invention. Control begins at block 600 with the device driver 118 detecting that a transfer operation has completed. In block 610, the device driver 118 determines whether the last issued transfer operation has completed. If so, processing continues to block 620, otherwise, processing is done. In block 620, the device driver 118 determines whether there are any transfer operations stored in one or more structures (e.g., structures 124, 126). If so, processing continues to block 630, otherwise, processing is done. In block 630, the device driver 118 issues the stored transfer operations to the I/O controller 122. In block 640, the device driver 118 performs transfer operation completion processing. This allows the stored transfer operations in the structure (e.g., structures 124, 126) to be issued without waiting for the transfer operation completion processing.

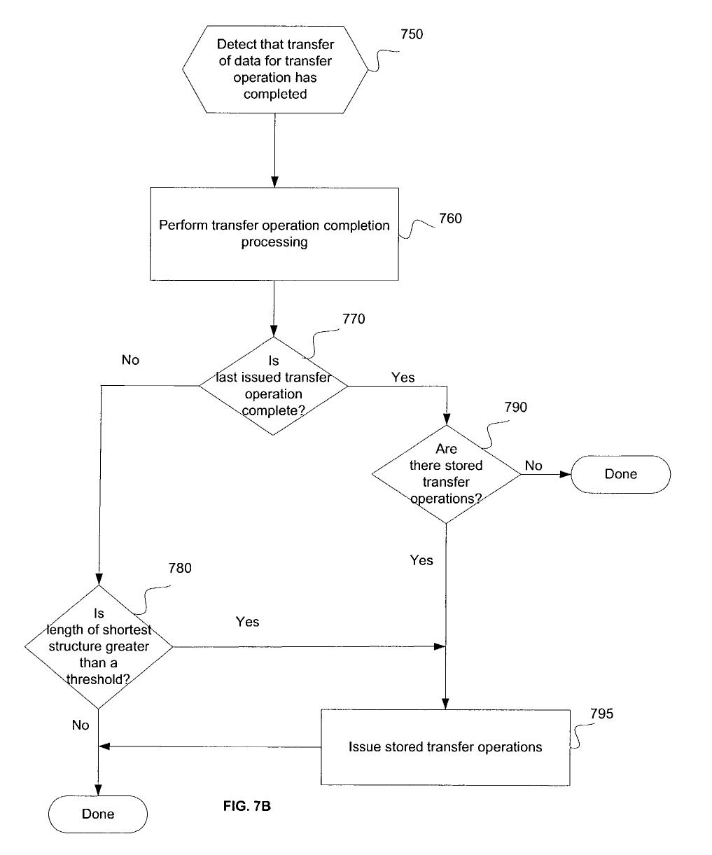

FIGS. 7A and 7B illustrate logic implemented in a device driver 118 for processing transfer operations in accordance with certain alternative embodiments of the invention. In certain embodiments, FIG. 7A represents processing by a Send Initiation function, while FIG. 7B represents processing by a Send Completion function. In certain embodiments, the device driver 118 ensures that the lengths of the one or more structures 124, 126 storing transfer operations do not exceed a threshold, which maybe set, for example, by a system administrator. For instance, depending on the characteristics of the I/O controller 122, the I/O controller 122 may be able to fetch a limited number of transfer operations at a time, such as 64 or 256. In this case, the lengths of the structures 124, 126 are monitored to ensure that they do not exceed the number of transfer operations that the I/O controller can fetch. Therefore, once the length threshold is exceeded (e.g., one or both structures 124, 126 has more than 64 transfer operations), then the device driver 118 issues the stored transfer operations without regard to whether the I/O controller 122 is currently processing previously issued transfer operations.

In FIG. 7A, control begins at block 700 with the device driver 118 receiving a transmit command issued by the operating system 110. In block 710, the device driver prepares a transfer operation. Instead of issuing the transfer operation to the I/O controller 122 immediately upon receipt of the transmit command from the operating system 110, the device driver 118 first checks whether the I/O controller 122 is currently processing previously issued transfer operations (block 720). In block 720, if the I/O controller 122 is processing other transfer operations, processing continues to block 730, otherwise, processing continues to block 745. In block 730, the device driver 118 determines whether the length of the shortest structure (i.e., among one or more structures, such as structures 124, 126) is greater than a threshold. If so, processing continues to block 745, otherwise, processing continues to block 740. In block 740, the device driver 118 stores the new transfer operation in a structure (e.g., one of the structures 124, 126). In block 745, the device driver 118 issues the new transfer operation along with any stored transfer operations.

In FIG. 7B, control begins at block 750 with the device driver 118 detecting that a transfer operation has completed. In block 760, the device driver 118 performs transfer operation completion processing. In block 770, the device driver 118 determines whether the last issued transfer operation has completed. If so, processing continues to block 790, otherwise, processing continues to block 780.

In block 780, the device driver 118 determines whether the length of the shortest structure (i.e., among one or more structures, such as structures 124, 126) is greater than a threshold. If so, processing continues to block 795, otherwise, processing is done.

In block 790, the device driver 118 determines whether there are any transfer operations stored in a structure (e.g., structures 124, 126). If so, processing continues to block 795, otherwise, processing is done. In block 795, the device driver 118 issues the stored transfer operations to the I/O controller 122.

In summary, a device driver 118 issues additional transfer operations to an I/O controller 122 immediately after the I/O controller 122 has finished processing previous transfer operations. This prevents one bus operation (e.g., the device driver 118 issuing a transfer operation) from conflicting with bus activity of the previous transfer operations (e.g., the I/O controller 122 transferring data across the bus from data buffers 134 to transfer structure 136). The device driver 118 detects when the I/O controller 122 has completed previous operations by monitoring completion indications from the I/O controller 122. While previously issued transfer operations are being processed, the device driver 118 prepares subsequent transfer operations for transmit commands that the device driver 118 is given by the operating system 110 and stores these transfer operations in one or more structures 124 and 126. Issuing the transfer operations does not interfere with the bus operations of the transfer operations being processed. Additionally, issuing multiple transfer operations to the I/O controller 122 at once is more efficient.

Embodiments of the invention are self-tuning. That is, thresholds are not set that are tuned to match the speed of the system on which embodiments of the invention are running or the current load of I/O or bus traffic. As the load on the system increases, then more transfer operations are queued and issued in a single operation. This automatically increases the efficiency of the device driver, the I/O controller, and the bus as needed. Conversely, when system loads are light, the transfer operations are issued with minimal latency.

Thus, transfer operations are issued in a manner to prevent any bus contention with processing of previously issued transfer operations. Additionally, transfer operations are stored together to allow for more efficient transfer operation issuance from the device driver 118 to the I/O controller 122 based on traffic flow loads. This allows sparse traffic flows to be processed quickly and not artificially delayed waiting for a threshold to be crossed, while heavy traffic flows are processed with minimum bus contention.

### Additional Embodiment Details

The described techniques for maintaining information on network components may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, flash, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In the described embodiments, certain logic operations were performed by the device driver 118. In alternative embodiments, these logic operations may be performed by another device, such as the I/O controller 122.

In the described embodiments, all stored transfer operations were issued with a new transfer operation. In alternative embodiments, a portion of the stored transfer operations may be issued with the new transfer operation.

In the described embodiments, the new transfer operation was not stored in a structure prior to being issued with stored transfer operations. In alternative embodiments, the new transfer operation may be stored prior to being issued with the previously stored transfer operations.

In the described embodiments, an operation was prepared before a determination of whether to defer operation processing for the operation was made. In alternative embodiments, preparation of the operation may also be deferred.

In the described embodiments, the data packets were transferred over a network 116. In alternative embodiments, the data packets may be transferred to local storage, to a peripheral device, or to another device without being transferred over the network 116.

Embodiments of the invention do not significantly change the code path lengths of the Send Initiation or Send Completion functions. Since throughput performance of high-speed I/O controllers under some operating systems corresponds to the length of the transmission code path in the device driver, the minor modification of the code path lengths of the Send Initiation or Send Completion functions does not significantly impact the throughput performance of high-speed I/O controllers.

The illustrated logic of FIGS. 3, 4, 5, 6, and 7A-7B describe specific logic operations occurring in a particular order. In alternative embodiments, certain of the logic operations may be performed in a different order, modified or removed. Moreover, steps may be added to the above described logic and still conform to the described embodiments. Further, logic operations described herein may occur sequentially or certain logic operations may be processed in parallel, or logic operations described as performed by a single process may be performed by distributed processes.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for processing an operation, comprising:
if previously issued operations are being processed, deferring operation processing; and
if previously issued operations are not being processed, issuing the operation and any operations for which operation processing was previously deferred and that require operation processing.

2. The method of claim 1, wherein deferring operation processing defers all operation processing.

3. The method of claim 1, wherein deferring operation processing defers a portion of the operation processing.

4. The method of claim 1, further comprising:
preparing the operation in response to receiving a transmit command from an operating system.

5. The method of claim 1, wherein the previously issued operations are being processed by an input/output controller.

6. The method of claim 1, wherein the operation and any operations for which operation processing was previously deferred are issued by a device driver.

7. The method of claim 1, further comprising:
detecting that processing of the issued operation has been completed.

8. The method of claim 7, further comprising:
performing operation completion processing.

9. The method of claim 7, further comprising:
determining whether a last issued operation has completed;
if the last issued operation has completed, determining whether there are any operations for which operation processing was previously deferred and that require operation processing; and
if there are operations that require operation processing, issuing the operations for which operation processing was previously deferred and that require operation processing.

10. The method of claim 9, further comprising:
if the last issued operation has not completed, determining whether a number of operations for which operation processing was previously deferred and that require operation processing exceeds a threshold; and
if the number of operations exceeds the threshold, issuing the prepared operation along with the operations for which operation processing was previously deferred and that require operation processing.

11. The method of claim 1, wherein deferring operation processing further comprises:
storing the operation in a structure.

12. The method of claim I 1, further comprising:
if the previously issued operations are being processed, before storing the operation in the structure, determining whether a number of operations stored in the structure exceeds a threshold; and
if the number of operations stored in the structure exceeds the threshold, issuing the prepared operation along with the operations for which operation processing was previously deferred and that require operation processing.

13. A system for processing an operation, comprising:
a processor;
memory coupled to the processor;
at least one program executed by the processor in the memory to cause the processor to perform:
(i) if previously issued operations are being processed, deferring operation processing; and
(ii) if previously issued operations are not being processed, issuing the operation and any operations for which operation processing was previously deferred and that require operation processing.

14. The system of claim 13, wherein the at least one program further causes the processor to perform:
detecting that processing of the issued operation has been completed.

15. The system of claim 14, wherein the at least one program further causes the processor to perform:
determining whether a last issued operation has completed;
if the last issued operation has completed, determining whether there are any operations for which operation processing was previously deferred and that require operation processing; and
if there are operations that require operation processing, issuing the operations for which operation processing was previously deferred and that require operation processing.

16. The system of claim 15, wherein the at least one program further causes the processor to perform:
if the last issued operation has not completed, determining whether a number of operations for which operation processing was previously deferred and that require operation processing exceeds a threshold; and
if the number of operations exceeds the threshold, issuing the prepared operation along with the operations for which operation processing was previously deferred and that require operation processing.

17. The system of claim 13, wherein deferring operation processing comprises storing the operation in a structure and wherein the at least one program further causes the processor to perform:
if the previously issued operations are being processed, before storing the operation in the structure, determining whether a number of operations stored in the structure exceeds a threshold; and
if the number of operations stored in the structure exceeds the threshold, issuing the prepared operation along with the operations for which operation processing was previously deferred and that require operation processing.

18. A system, comprising:
a device driver to,
(i) if previously issued operations are being processed, defer operation processing; and
(ii) if previously issued operations are not being processed, issue the operation and any operations for which operation processing was previously deferred and that require operation processing.

19. The system claim 18, wherein the device driver is capable to:
detect that processing of the issued operation has been completed;
determine whether a last issued operation has completed;
if the last issued operation has completed, determine whether there are any operations for which operation processing was previously deferred and that require operation processing; and
if there are operations that require operation processing, issue the operations for which operation processing was previously deferred and that require operation processing.

20. The system of claim 19, wherein the device driver is capable to:
if the last issued operation has not completed, determine whether a number of operations for which operation processing was previously deferred and that require operation processing exceeds a threshold; and
if the number of operations exceeds the threshold, issue the prepared operation along with the operations for which operation processing was previously deferred and that require operation processing.

21. The system of claim 18, wherein deferring operation processing comprises storing the operation in a structure and wherein the device driver is capable:
if the previously issued operations are being processed, before storing the operation in the structure, determine whether a number of operations stored in the structure exceeds a threshold; and
if the number of operations stored in the structure exceeds the threshold, issue the prepared operation along with the operations for which operation processing was previously deferred and that require operation processing.

22. An article of manufacture including a program for processing an operation, wherein the program causes operations to be performed, the operations comprising:
if previously issued operations are being processed, deferring operation processing; and
if previously issued operations are not being processed, issuing the operation and any operations for which operation processing was previously deferred and that require operation processing.

23. The article of manufacture of claim 22, the operations further comprising:
detecting that processing of the issued operation has been completed.

24. The article of manufacture of claim 23, the operations further comprising:
determining whether a last issued operation has completed;
if the last issued operation has completed, determining whether there are any operations for which operation processing was previously deferred and that require operation processing; and
if there are operations that require operation processing, issuing the operations for which operation processing was previously deferred and that require operation processing.

25. The article of manufacture of claim 24, the operations further comprising:
if the last issued operation has not completed, determining whether a number of operations for which operation processing was previously deferred and that require operation processing exceeds a threshold; and
if the number of operations exceeds the threshold, issuing the prepared operation along with the operations for which operation processing was previously deferred and that require operation processing.

26. The article of manufacture of claim 22, wherein deferring operation processing comprises storing the operation in a structure and the operations further comprising:
if the previously issued operations are being processed, before storing the operation in the structure, determining whether a number of operations stored in the structure exceeds a threshold; and
if the number of operations stored in the structure exceeds the threshold, issuing the prepared operation along with the operations for which operation processing was previously deferred and that require operation processing.

27. An article of manufacture including an operating system and device driver for processing an operation, wherein the operating system and device driver cause operations to be performed, the operations comprising:
if previously issued operations are being processed, deferring operation processing; and
if previously issued operations are not being processed, issuing the operation and any operations for which operation processing was previously deferred and that require operation processing.

28. The article of manufacture of claim 27, the operations further comprising:
detecting that processing of the issued operation has been completed;
determining whether a last issued operation has completed;
if the last issued operation has completed, determining whether there are any operations for which operation processing was previously deferred and that require operation processing; and
if there are operations that require operation processing, issuing the operations for which operation processing was previously deferred and that require operation processing.

29. The article of manufacture of claim 28, the operations further comprising:
if the last issued operation has not completed, determining whether a number of operations for which operation processing was previously deferred and that require operation processing exceeds a threshold; and
if the number of operations exceeds the threshold, issuing the prepared operation along with the operations for which operation processing was previously deferred and that require operation processing.

30. The article of manufacture of claim 27, wherein deferring operation processing comprises storing the operation in a structure and the operations further comprising:
if the previously issued operations are being processed, before storing the operation in the structure, determining whether a number of operations stored in the structure exceeds a threshold; and
if the number of operations stored in the structure exceeds the threshold, issuing the prepared operation along with the operations for which operation processing was previously deferred and that require operation processing.
